(19) United States
(12) Patent Application Publication
(10) Pub. No.: US 2013/0146688 A1
(43) Pub. Date: Jun. 13, 2013

(54) System and Method(s) for Recycling Lithium-Ion Batteries

(71) Applicants: John L. Palumbo, Wyckoff, NJ (US); Stephen A. Boyd, Manhasset, NY (US)

(72) Inventors: John L. Palumbo, Wyckoff, NJ (US); Stephen A. Boyd, Manhasset, NY (US)

(21) Appl. No.: 13/406,295

(22) Filed: Feb. 27, 2012

Related U.S. Application Data
(60) Provisional application No. 61/569,546, filed on Dec. 12, 2011.

(51) Int. Cl. B02C 17/20; B02C 23/00; B02C 23/08; B02C 17/24; B02C 17/02

(52) U.S. Cl. 241/22; 241/184; 241/176; 241/69; 241/24.25

(57) ABSTRACT

A system and methods for recycling lithium-containing battery materials are disclosed. More specifically, the system and method use a high energy ball mill for recrystallizing, reordering and/or reconstituting the lithium-ion containing battery material. In one embodiment, the system for recrystallizing the lithium-containing battery material restores it to its original state of functionality.

### RELATED APPLICATIONS

This application claims the benefit of U.S. Provisional Patent Application No. 61/569,546, filed Dec. 12, 2011, incorporated herein by reference in its entirety.

### FIELD OF THE INVENTION

The present invention generally relates to the field of lithium-ion batteries and recycling and/or recovering lithium-containing material therefrom. Thus, embodiments of the present invention pertain to methods and a system for recycling lithium-ion batteries. More specifically, embodiments of the present invention relate to a system and method for recycling lithium-ion batteries by utilizing high-energy ball milling to reorder the crystalline structure in which the lithium species is contained.

### DISCUSSION OF THE BACKGROUND

With the advent and popularization of portable electronic devices, as well as an increase in development and popularization of electric and hybrid electric vehicles, lithium-ion batteries have seen an increasing demand in usage. To date, no energy efficient, 90%+yield, solvent-free recycling scheme has been widely deployed that allows the effective recycling and repurposing of lithium-ion containing compounds.

The traversing of lithium ions (Li⁺) across electrolytic materials in a lithium-ion battery to and from positive electrode material induces disorder in the crystalline structure of the positive electrode. This disorder induces impurities in the crystalline structure of the positive electrode, changing the structure of the crystal, and thusly, the function. The induced structure(s) imposed by charging/discharging cycles of the battery eventually render the battery useless for its intended purpose.

Thus, there is a need for a system for recycling lithium-ion batteries and methods thereof.

This “Discussion of the Background” section is provided for background information only. The statements in this “Discussion of the Background” are not an admission that the subject matter disclosed in this “Discussion of the Background” section constitutes prior art to the present disclosure, and no part of this “Discussion of the Background” section may be used as an admission that any part of this application, including this “Discussion of the Background” section, constitutes prior art to the present disclosure.

### SUMMARY OF THE INVENTION

Embodiments of the present invention are generally related to a system for recycling Lithium-ion batteries and methods thereof. More specifically, embodiments of the present invention relate to a system and method for recycling lithium-ion batteries by utilizing high-energy ball milling of the spent material that that the lithium species is contained within, to reorder the crystalline structure of used lithium-containing battery materials where disorder has set in such that the battery no longer can provide electrical energy. The crystalline structure is then reordered to restore structure requisite for proper functioning of the battery material. The present system and method involve making and breaking chemical bonds contained within the crystalline structure of lithium-containing structures used in batteries using a high-energy ball mill, to reform the preferred structure(s) that perform electrical energy storage and/or production.

In one embodiment of the present invention, a system for recycling lithium-ion batteries comprises a ball mill suitable to break the crystalline bonds contained within the structure of lithium-containing compounds. More particularly, the system for recycling lithium-ion electrode material comprises a supply of spent lithium-ion electrode material, and a high-energy ball mill adapted to recrystallize, reorder and/or reconstitute the spent lithium-ion electrode material and/or render it with its original functionality.

In another embodiment, a method of recycling or recovering lithium-ion batteries (e.g., lithium-ion electrode material) comprises (a) supplying spent lithium-ion electrode material to a cylinder of a high-energy ball mill, (b) rotating the cylinder at a rotation rate, at a temperature, and for a length of time sufficient to recrystallize, reorder and/or reconstitute the spent lithium-ion electrode material and/or render the spent lithium-ion electrode material with its original functionality, and (c) removing the recrystallized and/or rendered lithium-ion electrode material from the cylinder.

The present invention advantageously provides a low-energy process for recycling and/or recovering reusable lithium-ion battery material from spent or used lithium-ion batteries, thereby reducing waste and minimizing energy consumption in the manufacture and/or processing of these highly useful materials. These and other advantages of the present invention will become readily apparent from the detailed description of various embodiments below.

### BRIEF DESCRIPTION OF THE DRAWINGS

FIG. 1 is a diagram showing a crystalline structure of a conventional lithium metal oxide ceramic for use in lithium ion batteries.

FIG. 2 depicts various crystal structures involved with the charging and discharging states of lithium ion battery materials in accordance with embodiments of the present invention.

FIG. 3 depicts structures of various lithium ion materials: (a) LiMO₂ (where M=Mn, Ni, and/or Co); (b) Li₂MnO₃ and Li₂TiO₃; (c) Li₂ZrO₃; and (d) Li₂MO₂ (where M=Mn and/or Ni) in accordance with other embodiments of the present invention.

FIGS. 4A-B depict a simplified high-energy ball mill, suitable for use in accordance with embodiments of the present invention.

FIG. 5 depicts a flow chart for the handling and processing of lithium ion electrode materials, from acceptance of the spent battery material through to the formation of the recycled material, in accordance with embodiments of the present invention.

### DETAILED DESCRIPTION

Reference will now be made in detail to various embodiments of the invention, examples of which are illustrated in the accompanying drawings. While the invention will be described in conjunction with the following embodiments, it will be understood that the descriptions are not intended to limit the invention to these embodiments. On the contrary, the invention is intended to cover alternatives, modifications and equivalents that may be included within the spirit and scope of the invention as defined by the appended claims. Furthermore, in the following detailed description, numerous specific details are set forth in order to provide a thorough understanding of the present invention. However, it will be readily apparent to one skilled in the art that the present invention may be practiced without these specific details. In other instances, well-known methods, procedures, components, and circuits have not been described in detail so as not to unnecessarily obscure aspects of the present invention.

So the manner in which various features of the present invention can be understood in detail, a more particular description of embodiments of the present invention, briefly summarized above, may be had by reference to embodiments, which are illustrated in the appended drawings. It is to be noted, however, the appended drawings illustrate only illustrative embodiments encompassed within the scope of the present invention, and therefore, are not to be considered limiting, for the present invention may admit to other equally effective embodiments.

Furthermore, all characteristics, measures or processes disclosed in this document, except characteristics and/or processes that are mutually exclusive, can be combined in any manner and in any combination possible. Any characteristic disclosed in the present specification, Claims, Abstract and Figures can be replaced by other equivalent characteristics or characteristics with similar objectives, purposes and/or functions, unless specified otherwise. Each characteristic is generally only an embodiment of the invention disclosed herein.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

Various embodiments and/or examples disclosed herein may be combined with other embodiments and/or examples, as long as such a combination is not explicitly disclosed herein as being unfavorable, undesirable or disadvantageous. The invention, in its various aspects, will be explained in greater detail below with regard to exemplary embodiments.

An Exemplary System

Embodiments of the present invention are generally related to a system for recycling lithium-ion batteries and methods thereof. More specifically, embodiments of the present invention relate to a system for recycling lithium-ion batteries by utilizing high-energy ball milling to reorder the crystalline structure that the lithium species is contained within. In one aspect, the present invention relates to a system for recycling lithium-ion electrode material, comprising a supply of spent lithium-ion electrode material, and a high-energy ball mill adapted to recrystallize, reorder and/or reconstitute the spent lithium-ion electrode material and/or render it with its original functionality. In one embodiment of the system, the high-energy ball mill is solventless. In another embodiment, the high-energy ball mill is adapted to use no acidic media and to perform no washings with a solvent.

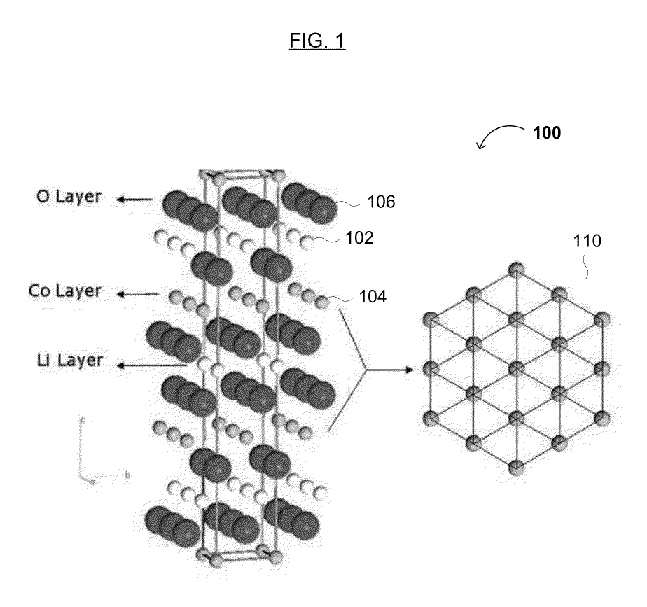

The lithium cobalt dioxide unit cell is depicted in FIG. 1. FIG. 1 depicts a model of the LiCoO₂ crystal structure 100, including Li layers 102, Co layers 104, and oxygen layers 106 between alternating Li and Co layers 102 and 104, where the FIG. 110 on the right is that of the cobalt layer 104, in accordance with one embodiment of the present invention. Here, the idealized positions of all the atoms/ions in the unit cell are depicted. Upon cycling of a number of charge/discharge states, the crystalline structural parameters change, resulting in a loss of the lithium ions' capability to move from positive electrode to negative electrode in sufficient number and rate to maintain a useful battery in a device requiring electrical power.

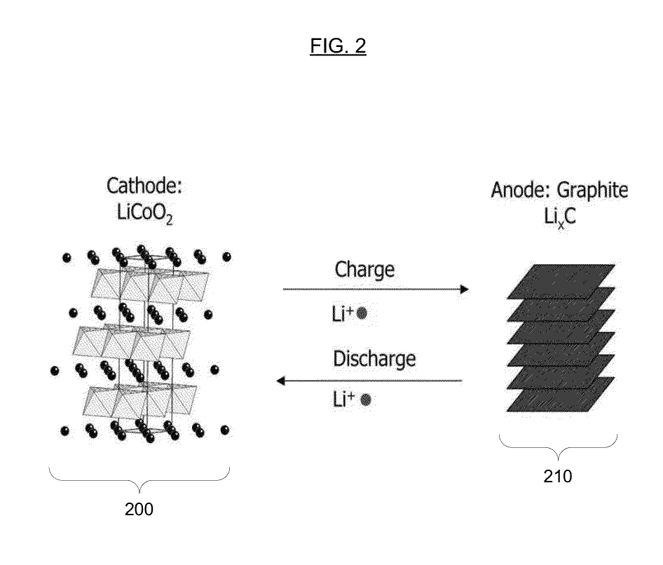

FIG. 2 illustrates representations of the crystal structures involved with the charging and discharging states in accordance with another embodiment of the present invention. In particular, FIG. 2 depicts a diagram showing the directionality of the lithium-ion flow during charging and discharging states. For example, during the battery charging process 205, lithium ions flow from the LiCoO₂ cathode 200 to the graphite anode 210. During the battery discharging process 215, lithium ions flow from the graphite anode 210 to the LiCoO₂ cathode 200. The gradual degradation of the capacity of the battery is a result of the loss of the lithium ions to be successfully transported from positive electrode 200 to negative electrode 210 in sufficient number.

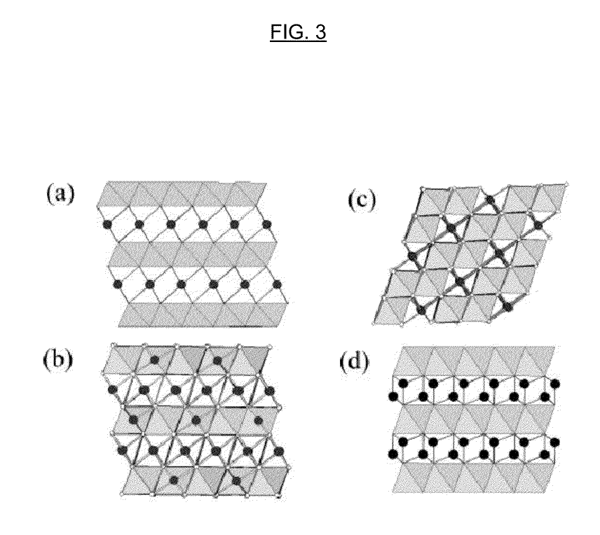

FIG. 3 depicts idealized ordering of atomic species of some of the lithium-containing compounds that may function as positive electrodes in lithium-ion batteries. For example, FIG. 3 depicts structures of various lithium metal oxide electrode materials useful in accordance with yet other embodiments of the present invention: (a) LiMO₂ (where M =Mn, Ni and/or Co); (b) Li₂MnO₃ and Li₂TiO₃; (c) Li₂ZrO₃; and (d) Li₂MO₂ (where M=Mn and/or Ni). Thus, in some embodiments of the present system, the spent lithium-ion electrode material comprises a lithium metal oxide of the formula LiₓM0_{y}, where M is a transition metal that has a stable formal oxidation state of +2, +3 and/or +4, and y=(x+z)/2, where z is the formal oxidation state of M, and x is 1 or 2. In certain embodiments of the system, x is 1 and M is Co or Ni.

High-energy ball milling (HEBM) has proven to synthesize LiMO₂ materials (where M is any transition metal) that perform equally well as a positive electrode material (e.g., as a cathode 200 in FIG. 2) to those synthesized via other synthetic routes (e.g., ion exchange, solid-phase metal oxide and/or hydroxide synthesis, intercalation, etc.). Due to the decreasing particle size and the intense mechanical energy input to the reactant species, LiMO₂ materials may be synthesized using HEBM at room temperature (e.g., from about 15° C. to about 30° C., about 18° C. to 25° C., or any other range of temperatures therein). In addition, the size of the crystallites of a given sample may be controlled by careful heating (e.g., to a temperature in the range of about 50° C. to about 1000° C., about 100° C. to 300° C., or any other range of temperatures therein) in a manner unprecedented by other synthetic techniques.

Typically, to facilitate the appropriate structure and crystallite size provided by non-HEBM techniques, heating in a high temperature furnace for several hours is generally required. The advantages of the HEBM synthetic technique includes reducing the temperature and/or time for fabrication of a material that parallels, and in some cases may outperform, currently available materials. Using the HEBM technique, it is possible to “synthesize” LiMO₂ and other positive cathode materials from spent electrode materials, and at the same time, reduce the energy requirements by drastic amounts in the synthesis of these materials.

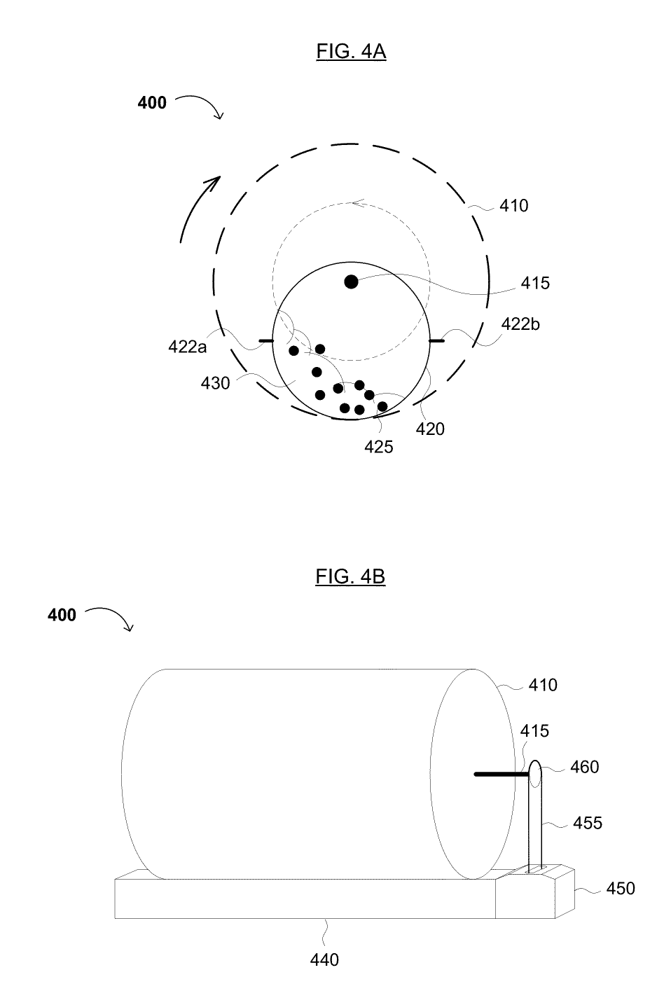

Referring to FIG. 4A, a cross-section of a simplified HEBM apparatus 400 is shown. The HEBM apparatus 400 comprises an outer cylinder 410, central axis 415, an inner (or milling) cylinder 420, balls 425, and spent lithium ion electrode material 430. In general, the outer cylinder 410 is rotated about central axis 415. In one embodiment, pegs or rails 422a-b may be mounted or located on the outer surface of the inner cylinder 420. The pegs or rails 422a-b may be adapted to fit into holes or slots 412 in the outer cylinder 410 to prevent the inner cylinder 420 from rotating around its own central axis and enable the inner cylinder 420 to rotate along a circle 435 defined by the rotation of the central axis of the inner cylinder 420 around the central axis 415 of the outer cylinder 410, thereby imparting significantly greater force to the balls 425. Alternatively, pegs or rails 422a-b may be absent from the surface of the inner cylinder 420, in which case the inner cylinder 420 rotates in the direction of the outer cylinder 410, but at a faster rate than the outer cylinder 410.

In an alternative embodiment, the high-energy ball mill may comprise a planetary ball mill. Referring to FIG. 4A, in a planetary ball mill, a single milling cylinder 420 stands upright on a rotating disc 410. The milling cylinder 420 may rotate in the same direction or in the opposite direction as rotating disc 410. Generally, central axis 415 and pegs or rails 422a-b are absent from a planetary ball mill. In further embodiments, the rotating disc 410 is configured or adapted to hold up to eight milling cylinders 420 (e.g., 2, 4 or 8 cylinders), in which case the diameter of each milling cylinder 420 is less than half of the diameter of the rotating disc 410 (e.g., about 20% to about 25% in the case of 8 cylinders, and about 30-45% in the case of 4 cylinders).

FIG. 4B shows an external view of the simplified HEBM apparatus 400 of FIG. 4A, including outer cylinder 410, central axis 415, base 440, and motor 450. The motor 450 drives a belt 455, which in turn, rotates a wheel 460 to which central axis 415 is fixed or integrated. In the embodiment shown, the outer cylinder 410 is also fixed to or integrated with the central axis 415. Alternatively, motor 450 may drive a gear mechanism including a terminal gear to which the central axis 415 is fixed or integrated. In a further embodiment, the base 440 may include one or more rollers (not shown) that contact the outer cylinder 410. When the motor 450 drives a belt or gear mechanism, the roller(s) may simply provide mechanical support for the outer cylinder 410. Alternatively, the motor 450 may drive the roller(s), directly or using a belt or gear mechanism similar to that described herein.

Thus, in various embodiments of the system, the high-energy ball mill comprises an outer cylinder or a rotating disc or plate, a milling cylinder on the rotating disc/plate or completely contained inside the outer cylinder, a plurality of balls inside the milling cylinder, and a motor configured to rotate at least one of the outer cylinder and the milling cylinder. The balls are generally adapted to impart mechanical energy on (e.g., grind and/or pulverize) the spent lithium-ion electrode material.

The present ball mill can operate continuously, in which the lithium metal oxide electrode material is fed into one end, and is discharged at the other end. The present ball mill may be a large to medium-sized ball mill, and be mechanically rotated on its axis (e.g., central axis 415).

The rotation rate of the outer cylinder 410 is generally kept below the “critical speed.” The critical speed of the rotation of the outer cylinder 410 can be understood as that speed after which the balls 425 (which are responsible for the grinding of the spent lithium-ion electrode material) start rotating along the direction of the cylindrical device, thereby causing no further grinding.

The simplified HEBM apparatus 400 can grind various lithium metal oxide ceramics and other materials either wet or dry. However, the simplified HEBM apparatus 400 is preferably solventless (e.g., contains no ports, conduits or storage vessels for introducing solvents into the HEBM apparatus 400). The present HEBM apparatus 400 may be one of two kinds of ball mill, either a grate type or an overfall type, which are distinguished from each other by the different ways in which material is discharged.

There are many types of grinding media (e.g., balls 425) suitable for use in the present ball mill 400, each material for the grinding media having its own specific properties and advantages. Key properties of grinding media include size, density, hardness, and composition.

In general, the smaller the balls 425, the smaller the particle size of the recycled/recovered lithium-ion electrode material. For example, the smaller the particle size of the recycled/recovered lithium-ion electrode material, the higher the yield and/or the higher the activity of the recycled/recovered lithium-ion electrode material. Also, the balls 425 should be larger or substantially larger than the largest pieces of the spent lithium-ion electrode material to be ground. Thus, in one example, the spent lithium-ion electrode material may be broken up into pieces smaller than the size of the balls 425. Further, balls 425 may have a plurality of different sizes, to facilitate both functions (i.e., grinding relatively large pieces of spent lithium-ion electrode material, and producing recovered lithium-ion electrode material having a relatively small particle size).

The plurality of balls 425 should (and preferably does) have a density greater than the spent lithium-ion electrode material being ground. It can take greater energy to grind the spent lithium-ion electrode material if the balls 425 float on the spent lithium-ion electrode material being ground.

The balls 425 should be durable and/or have a hardness sufficient to grind the spent lithium-ion electrode material, but if and/or when possible, not so hard that the balls 425 also wear down the inner/milling cylinder 420 (or the inner surface thereof). Thus, the plurality of balls in the present system may comprise a metal or alloy having a hardness greater than that of the spent lithium-ion electrode material.

Although the simplified HEBM apparatus 400 does not, in general, have special requirements, some conditions on the material or composition of the balls 425 may be taken into consideration. For example, if some material from the balls 425 is included in the recycled and/or recovered lithium-ion electrode material (whether inadvertently or by design), the balls 425 may include the same metal as is present in the lithium metal oxide ceramic. Other materials that may react with the lithium-ion electrode material should be avoided. The material for the balls 425 may be selected for ease of separation from the recycled and/or recovered lithium-ion electrode material (e.g., stainless steel balls may be selected so that steel dust produced from the grinding process can be magnetically separated from the recycled and/or recovered lithium-ion electrode material).

In addition, in some embodiments, additives such as lithium carbonate and/or a metal oxide of the formula MₐO_{b} (where M is a transition metal with an oxidation state of +x, a*x is an even integer, and y=[a*x]/2) may be added to maximize the yield of the recycled material. Thus, in further embodiments of the present invention, lithium-containing positive electrode material may be doped with other transition metals (e.g., in the formula MₐO_{b}) to enhance electrical performance during the high energy ball milling process.

The milling cylinder 420 may be filled with an inert gas (e.g., N₂, Ar, etc.) that does not react with the lithium-ion electrode material being ground and/or with the balls 425, to prevent oxidation and/or reactions that could occur with ambient air, carbon dioxide, etc., inside the milling cylinder 420.

In one embodiment of the present invention, it has been shown that lithium cobalt oxide can be synthesized in a manner consistent with high energy ball milling, and sintered in a furnace no hotter than 400° C.

An Exemplary Method

The present invention further relates to a method for recycling lithium-ion batteries by utilizing high-energy ball milling to reorder the crystalline structure that the lithium species is contained within. More specifically, the method of recycling or recovering lithium-ion electrode material comprises (a) supplying spent lithium-ion electrode material to a cylinder of a high-energy ball mill, (b) rotating the cylinder at a rotation rate, at a temperature, and for a length of time sufficient to recrystallize, reorder and/or reconstitute the spent lithium-ion electrode material and/or render the spent lithium-ion electrode material with its original functionality, and (c) removing the recrystallized and/or rendered lithium-ion electrode material from the cylinder. Advantageously, the method is less energy intensive than chemical synthesis techniques, such as solid-phase synthesis, high-temperature diffusion and crystallization, etc. As discussed above, in various embodiments, the present method is solventless, uses no acidic media, and/or includes no washings with a solvent.

In one embodiment, the method comprises placing the spent lithium-ion electrode material in a milling cylinder of an HEBM apparatus completely contained inside an outer cylinder of the HEBM apparatus, rotating the outer cylinder, and grinding and/or pulverizing the spent lithium-ion electrode material using a plurality of balls inside the milling cylinder. The balls may comprise a metal or alloy having a hardness greater than that of the spent lithium-ion electrode material, as discussed herein.

The lithium-ion electrode material may comprise a lithium metal oxide of the formula LiₓMO_{y}, where M is a transition metal that has a stable formal oxidation state of +2, +3, and/or +4 (although not necessarily when in the spent lithium-ion electrode material), and y=(x+z)/2, where z is the formal oxidation state of M, and x is 1 or 2. In various embodiments, the method may further comprise adding an electrode source material such as lithium carbonate and/or a transition metal oxide (e.g., of the formula MₐO_{b} above) to increase or maximize the yield of the recycled material, or introduce a different transition metal dopant into the ceramic electrode material. The method may, alternatively or additionally, further comprise filling or introducing an inert gas (e.g., N₂, Ar, etc.) into the milling cylinder.

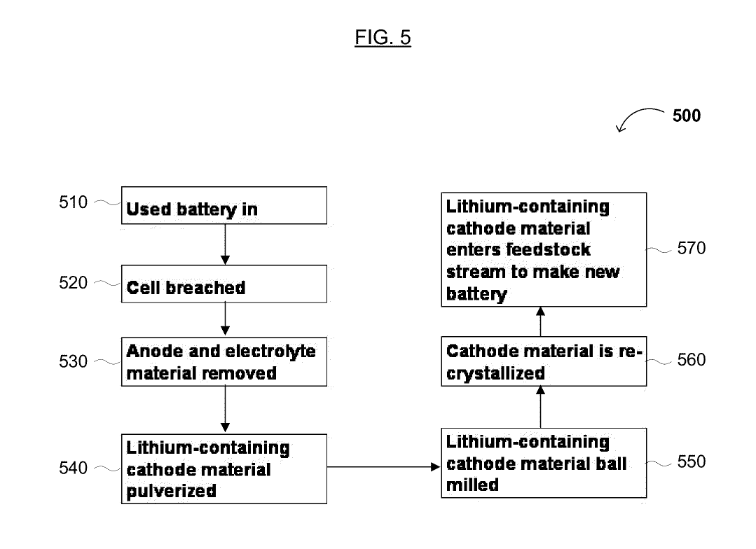

FIG. 5 is a flow chart 500 depicting one of the possible material handling procedures that can occur when recycling lithium-ion containing positive electrodes. Flow chart 500 depicts the handling and processing, from acceptance of the spent battery material through to the formation of the recycled material, in accordance with an embodiment of the present invention.

For example, at 510, the used battery is taken in to the recycling and/or recovery facility. At 520, the battery cell is breached, generally by breaking open a casing or housing containing the cell. The battery cell may be breached in accordance with techniques known in the art. At 530, the anode (e.g., a graphite anode) and the electrolyte (e.g., an aqueous solution comprising a salt, such as lithium chloride) are removed from the cell, generally using one or more techniques known in the art. After 530, the lithium-ion containing cathode is isolated from the battery, and the other components of the battery may be recovered or disposed of separately, in accordance with techniques known in the art.

At 540, the lithium-ion containing cathode material (e.g., a lithium metal oxide, as described herein) is pulverized, for example, into pieces or chunks smaller than the largest of the balls in the HEBM apparatus. In one embodiment, the cathode material is pulverized by crushing, using a conventional press. At 550, the pulverized lithium metal oxide ceramic is placed or fed into the ball mill (e.g., a high-energy ball mill), and milled at a rotational rate, at a temperature, and for a length of time sufficient to substantially reorder and/or recrystallize the lithium metal oxide to a state providing functionality for use in a battery (or other battery-related application) at 560. In a preferred embodiment, the lithium metal oxide ceramic is ball milled at room temperature. One skilled in the art can determine (e.g., empirically) the rotation rate and the length of time for ball milling, as well as various other parameter values (e.g., the size and mass of the balls, whether and how to control the atmosphere inside the milling cylinder, etc.). As mentioned above, before 550, additional source materials (e.g., Li₂CO₃, one or more transition metal oxides, etc.) may be added to the ball mill prior to milling. The lithium metal oxide ceramic is then removed from the cylinder (e.g., through a grate by or an overfall or overflow method), and the lithium metal oxide ceramic may be introduced into a feedstock stream at 570 (e.g., to make a new battery).

Although not intended to be limiting, the following parameters and values or value ranges therefor may be useful in practicing the present invention, although other values or value ranges may also be useful in certain applications (e.g., larger milling cylinder volumes may be useful for larger-scale recycling/recovery operations):

Rotation rates: 30-1000 rpm (e.g., 300-400 rpm)

Grinding jar (e.g., milling cylinder) volume: 3-1000 mL (e.g., 500 mL)

Temperatures: −200-200° C. (e.g., 0 to 50° C., or 18 to 25° C.)

Ball diameters: 0.5-10 cm (e.g., 20 mm)

Ball masses: 1-500 g (e.g., about 5 g)

Size of pulverized spent Li metal oxide to be milled: 0.1-5 cm (e.g., about 1 mm)

Particle size of recycled/recovered Li metal oxide: 1 nm-100 microns (e.g., about 5 nm

### CONCLUSION/SUMMARY

While the foregoing is directed to embodiments of the present invention, other and further embodiments of the invention may be devised without departing from the basic scope thereof. It is also understood that various embodiments described herein may be utilized in combination with any other embodiment described, without departing from the scope contained herein. In addition, embodiments of the present invention are further scalable to allow for additional clients and servers, as particular applications may require.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A system for recycling lithium-ion electrode material, comprising:
a) a supply of spent lithium-ion electrode material;
b) a high-energy ball mill adapted to recrystallize, reorder and/or reconstitute the spent lithium-ion electrode material and/or render it with its original functionality.

2. The system of claim 1, wherein the high-energy ball mill is solventless.

3. The system of claim 1, wherein the high-energy ball mill is adapted to use no acidic media and to perform no washings with a solvent.

4. The system of claim 1, wherein the high-energy ball mill comprises:
a) an outer cylinder or rotating disc or plate;
b) a milling cylinder completely contained inside the outer cylinder or on the rotating disc or plate;
c) a plurality of balls inside the milling cylinder, each of said balls having a adapted to grind and/or pulverize the spent lithium-ion electrode material; and
d) a motor configured to rotate at least one of the outer cylinder and the milling cylinder.

5. The system of claim 4, wherein the plurality of balls comprises a metal or alloy having a hardness greater than that of the spent lithium-ion electrode material.

6. The system of claim 1, wherein the spent lithium-ion electrode material comprises a lithium metal oxide of the formula LiₓMO_{y}, where M is a transition metal that has a stable formal oxidation state of +2 and/or +3, and (x+3−z)/2≦y≦(x+3+z)/2, where z is 0, 1 or 2.

7. The system of claim 6, wherein x is 1 and M is Co or Ni.

8. The system of claim 1, wherein the high-energy ball mill further comprises a grate or an overfall mechanism configured to remove the ground and/or pulverized lithium-ion electrode material from the high-energy ball mill.

9. The system of claim 1, wherein the high-energy ball mill is configured for continuous operation.

10. A method of recycling or recovering lithium-ion electrode material, comprising:
a) supplying spent lithium-ion electrode material to a cylinder of a high-energy ball mill;
b) rotating the cylinder at a rotation rate, at a temperature, and for a length of time sufficient to recrystallize, reorder and/or reconstitute the spent lithium-ion electrode material and/or render the spent lithium-ion electrode material with its original functionality; and
c) removing the recrystallized and/or rendered lithium-ion electrode material from the cylinder.

11. The method of claim 10, wherein the method is less energy intensive than chemical synthesis techniques.

12. The method of claim 10, wherein the method is solventless.

13. The method of claim 10, wherein the method uses no acidic media and no washings with a solvent are performed.

14. The method of claim 10, wherein:
a) the spent lithium-ion electrode material is placed in a milling cylinder completely contained inside an outer cylinder or on a rotating disc or plate;
b) at least one of (i) the outer cylinder or the rotating disc or plate and (ii) the milling cylinder is rotated; and
c) a plurality of balls inside the milling cylinder grind and/or pulverize the spent lithium-ion electrode material.

15. The method of claim 14, wherein the plurality of balls comprises a metal or alloy having a hardness greater than that of the spent lithium-ion electrode material.

16. The method of claim 10, wherein the spent lithium-ion electrode material comprises a lithium metal oxide of the formula LiₓMO_{y}, where M is a transition metal that has a stable formal oxidation state of +2 and/or +3, and (x+3−z)/2≦y ≦(x+3+z)/2, where z is 0, 1 or 2.

17. The method of claim 16, wherein x is 1 and M is Co or Ni.

18. The method of claim 10, wherein the cylinder is rotated at room temperature.

19. The method of claim 10, further comprising pulverizing the spent lithium-ion electrode material prior to supplying the spent lithium-ion electrode material to the cylinder of the high-energy ball mill.

20. The method of claim 10, further comprising adding an electrode source material to the cylinder of the high-energy ball mill prior to rotating the cylinder, wherein the electrode source material is selected from the group consisting of carbonates and oxides of lithium and transition metals.
